(19) United States
(12) Patent Application Publication
(10) Pub. No.: US 2008/0313152 A1
(43) Pub. Date: Dec. 18, 2008

(54) Real-Time Digital Video Identification System and Method Using Scene Information

(75) Inventors: Young-Suk Yoon, Seoul (KR); Sung-Hwan Lee, Daejeon (KR); Wonyoung Woo, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 12/094,977

(22) PCT Filed: Nov. 28, 2006
(86) PCT No.: PCT/KR2006/005052

§ 371 Date: May 23, 2008

(30) Foreign Application Priority Data
Dec. 9, 2005 (KR) 10-2005-0120323

(51) Int. Cl. G06F 17/30

(52) U.S. Cl. 707/3

(57) ABSTRACT

Provided is a real-time digital video identification system for searching and identifying a digital video in real-time by effectively constructing a database using a scene length of a digital video, and a method thereof. The system includes: a scene information extractor for receiving a digital video, extracting a difference between frames of the received digital video, detecting a scene change portion and calculating a scene length using the portions; a digital video database for storing a plurality of digital videos and scene lengths corresponding to the stored digital videos; and a digital video comparator for receiving the calculated scene length from the scene information extractor, sending a query to the digital video database and comparing the received scene length with the response of the query from the digital database.

### TECHNICAL FIELD

The present invention relates to a digital video identification technology, and more particularly, to a real-time digital video identification system for searching and identifying a digital video in real-time by effectively constructing a database using a scene information of a digital video, and a method thereof.

### BACKGROUND ART

Due to the dramatic development of technology for producing and processing a digital video and the introduction of various related tools, a user is allowed to easily modify a digital video. Many multimedia users also demand a high-quality and a mass quantity digital video according to the evolution of the communication network and the storage medium.

Fast search and accurate comparison have been recognized as a major object to develop for providing a multimedia service that requires processing of the high-quality and the mass quantity digital video. For example, it is impossible to allow a monitoring system to search a common database management system to find an advertisement currently broadcasted through the air by comparing frames of the currently broadcasted advertisement and those of the advertisements stored in the universal database management system because the monitoring system must store a plurality of advertisement broadcasting programs in the common database management system in order to provide a service in real time.

Therefore, the digital video database uses information about properties of each digital video to manage the stored digital videos. The present invention relates to a technology using a scene of a digital video which is one of these properties for managing the digital video. All videos are composed of many scenes meaning the set of semantically similar frames. If a digital video were not corrupted by noises, it should have a set of scenes with a unique length. A scene information of a digital video can provides a scene change, a scene length, a key frame, and a variation and so on. In hence, such a characteristic of the digital video can be used for searching and identifying a digital video in real time exploiting the scene information in the present invention.

Many conventional technologies related to the scene were introduced and related patents were published.

A conventional system of detecting a scene change from a video stream compressed based on a MPEG standard is introduced in Korea Patent Application 10-70567, entitled “HOT DETECTING METHOD OF VIDEO SYSTEM” filed at Nov. 24, 2000. In the conventional system, the scene change is detected using AC coefficients after applying a discrete cosine transform (DCT) which is used to eliminate a spatial redundancy. The conventional system may reduce errors to detect the scene change, which is caused by a light variation, by obtaining histograms of edge images in a video stream using the AC coefficient and referring the distribution thereof.

Another conventional apparatus for detecting a scene change is introduced in Korea Patent Application No. 10-86096, entitled “APPARATUS FOR DETECTING SCENE CONVERSION,” filed at Dec. 27, 2001. The conventional apparatus detects the scene change as follows. The conventional apparatus obtains the histogram using consecutively-recovered frames as an input. Then, the conventional apparatus obtains accumulated histogram thereof and creates a pixel value list based on 20%, 40%, 60% and 80% of pixels. Finally, the conventional apparatus compares the created pixel values to detect the scene change. In order to reduce errors of detecting the scene change, the conventional apparatus determines whether an image is influenced by a light through selecting a brightness variation model of image changed according to the light variation and comparing a difference between two frames's histograms with a threshold.

Meanwhile, various computable parameters of image for classification are introduced in an article by Z. Rasheed, Y. Sheikh and M. Shah, entitled “On the use of computable features for film classification” in IEEE transactions on Circuits and Systems for Video Technology, Vol. 15, No. 1, pp. 52-64, 2005. The computable parameters include a scene change. The article also introduces a conventional technology for detecting the scene change. That is, a color domain is transformed to a Hue Saturation Value (HSV) and histograms are created to have 8, 4, 4 bins with the HSVs. Then, an intersection of the histograms of the consecutive frames is obtained and an anisotropic diffusion algorithm is applied to the obtained intersection to detect the scene change.

Another conventional technology related to the scene change, a conventional system of searching a video stream broadcasted through an air is introduced in an article by Xavier Naturel and Patrick Gros, entitled “A fast shot matching strategy for detecting duplicate sequence in a television stream,” in Proceedings of the 2nd ACM SIGMOD international Workshop on Computer Vision meets Databases, June 2005. The conventional system uses a simple computation to search the video stream in real time. That is, the conventional system introduced in the article detects a scene change portion by calculating brightness histogram of consecutively-reconstructed frames and obtaining a difference thereof.

However, these conventional technologies fail to teach details of technical solutions for searching and identifying a digital video in a real time within a mass capacity digital video database. That is, simple computation and quick scene change search are not disclosed by these conventional technologies.

### DISCLOSURE OF INVENTION

### Technical Problem

Accordingly, the present invention is directed to a real-time digital video identification system using a scene information and a method thereof, which substantially obviates one or more problems due to limitations and disadvantages of the related art.

It is an object of the present invention to provide a real-time digital video identification system for searching and identifying a digital video in real time by using a scene information detecting a scene change portion between digital video frames and comparing the calculated scene length with scene lengths of digital videos stored in a database.

### Technical Solution

To achieve these objects and other advantages and in accordance with the purpose of the invention, as embodied and broadly described herein, there is provided a real-time digital video identification system including: a scene information extractor for receiving a digital video, extracting a difference between frames of the received digital video and calculating a scene length using the extracted difference; a digital video database system for storing a plurality of digital videos and scene lengths corresponding to the stored digital videos; and a digital video comparator for receiving the calculated scene length from the scene information extractor, sending a query to the digital video database and comparing the received scene length with the response of the query from the database system.

According to another aspect of the present invention, there is provided a method of identifying a digital video in real time including the steps of: a) extracting a difference between frames of an input digital video using a rate of brightness variation larger than a threshold between frames of the input digital video; b) detecting the location of scene change exploiting the scene change detecting filter with local minimum and maximum filter c) calculating a length of frames as a scene length using the extracted scene change portion of the digital video at the step b); d) sending the calculated scene length as a query to a digital video database previously built; e) comparing the calculated scene length with a scene length registered corresponding to a digital video ID outputted as a result of the query; and f) determining whether a currently inputted digital video is registered in the digital video database or not through determining whether the calculated scene length is identical to a scene length of a digital video registered in the database within a threshold range.

### ADVANTAGEOUS EFFECTS

A real-time digital video identification system according to the present invention allows the real-time identification of the digital video by calculating a scene length using a scene change portion between frames of a digital video and comparing the calculated scene length of other digital videos previously stored in a digital video database.

In order to identify and search a digital video in real time using a scene length, the present invention proposes a method of identifying a digital video in real time that simply calculates a rate of brightness variation between frames larger than a threshold at a difference extractor, searches a scene change portion at a scene change detecting filter configured of a maximum filter and a minimum filter, storing a set of N scene lengths in a digital video database system and allowing the digital video database to search within a threshold instead of using a predetermined measure to search. Also, the real-time digital video identification system according to the present invention uses three consecutive scene lengths as an input of the difference extractor to provide a steady level of performance for the continuous scene change. Moreover, a comparator of the present invention can use various features such as edge information, several histograms, optical flow, color layout descriptor and so on.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a real-time digital video identification system according an embodiment of the present invention;

FIG. 2 is a block diagram showing the scene information extractor 10 shown in FIG. 1

FIG. 3 is a view illustrating frames of a digital video based on a time domain;

FIG. 4 is a view for describing a principle of a scene change used in a real-time digital video identification system according to the present invention;

FIG. 5 shows a scene change of real frames;

FIG. 6 shows a signal inputted to the difference extractor shown in FIG. 2;

FIG. 7 shows graphs for describing operations of the scene detection filter 12 shown in FIG. 2;

FIG. 8 shows a database for scene lengths in a digital video database according to the present invention; and

FIG. 9 is a flowchart showing a method of identifying a digital video in real time using a scene length according to an embodiment of the present invention.

### BEST MODE FOR CARRYING OUT THE INVENTION

Reference will now be made in detail to the preferred embodiments of the present invention, examples of which are illustrated in the accompanying drawings.

A real-time digital video identification system according to the present invention may be applicable to a mass capacity multimedia service that requires a real-time processing for searching and monitoring a digital video.

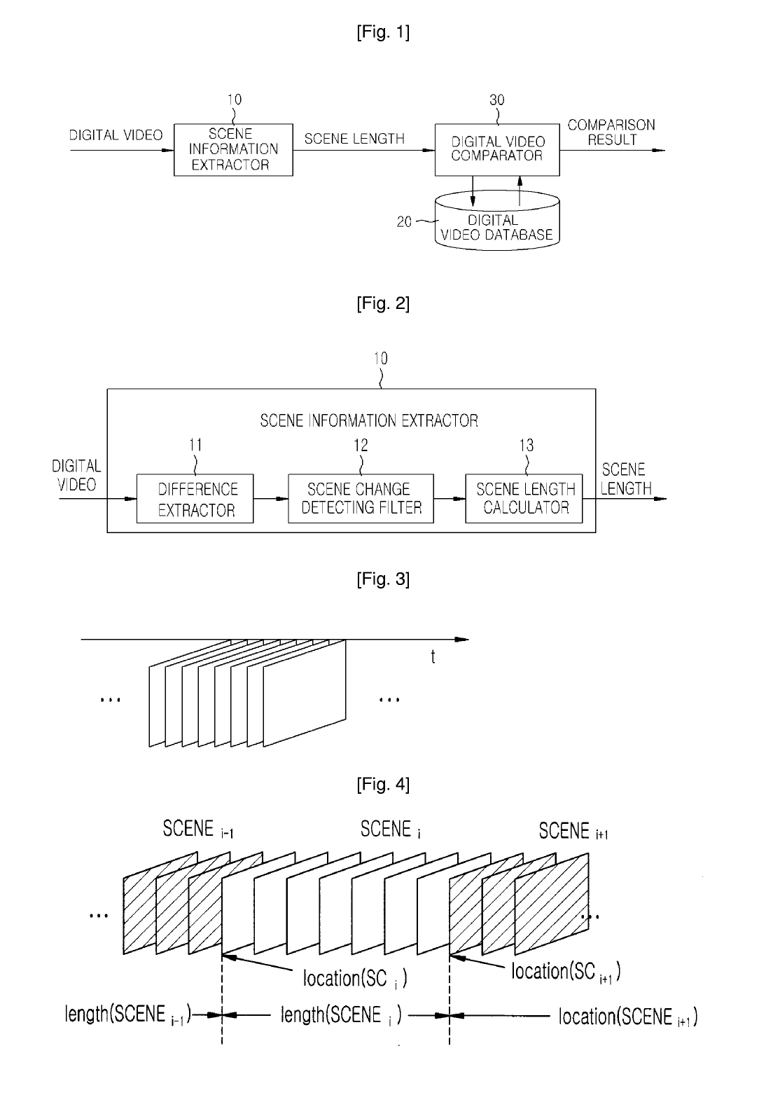

FIG. 1 is a block diagram illustrating a real-time digital video identification system according an embodiment of the present invention.

As shown in FIG. 1, the real-time digital video identification system according to the present embodiment includes a scene information extractor 10, a digital video database 20 and a digital video comparator 30.

The scene information extractor 10 receives digital video, extracts differences between frames of the received digital video, and computes a scene length based on the extracted differences. The digital video database 20 stores a plurality of digital videos, scene lengths of the stored digital videos. The digital video database 20 will be described in later. The digital video comparator 30 receives the computed scene length from the scene information extractor 10 and compares the received scene length with scene lengths stored in the digital video database 20. Then, the digital video comparator 30 outputs the comparison result. From the comparison result, it is possible to determine whether the digital video database 20 stores a digital video identical to the received digital video or not.

FIG. 2 is a block diagram showing the scene information extractor 10 shown in FIG. 1.

As shown in FIG. 2, the scene information extractor 10 includes a difference extractor 11, a scene change detecting filter 12 and a scene length calculator 13. The difference extractor 11 receives a digital video and extracts the difference between frames of the received digital video. The scene change detecting filter 12 composed of local maximum and minimum filters detects a scene change portion using the extracted difference. The scene length calculator 13 computes the scene length using the detected scene change portion.

FIG. 3 is a view illustrating frames of a digital video based on a time domain, and FIG. 4 is a view for describing a principle of a scene change used in a real-time digital video identification system according to the present invention.

As shown in FIG. 3, the digital video is a set of consecutive frames and has many temporal and spatial redundancies. The vertical axis in FIG. 3 denotes a time.

FIG. 4 shows a scene that is a set of frames connected according to a semantic context of a digital video. Herein, scenes SCENEᵢ₋₁ and SCENEᵢ have semantically different scene configurations and contexts, and a scene change exists at a boundary between two scenes. For example, the scene change portion exists between scenes SCENEᵢ₋₁ and SCENEᵢ or SCENEᵢ and SCENEᵢ₊₁, and locations of each scene change on the frames are defined as location(SCᵢ₋₁) and location(SCᵢ). Herein, a scene length denotes a frame distance in the scene change portion length(SCENEᵢ) as shown in FIG. 4. However, the scene length can be defined as a duration of scene.

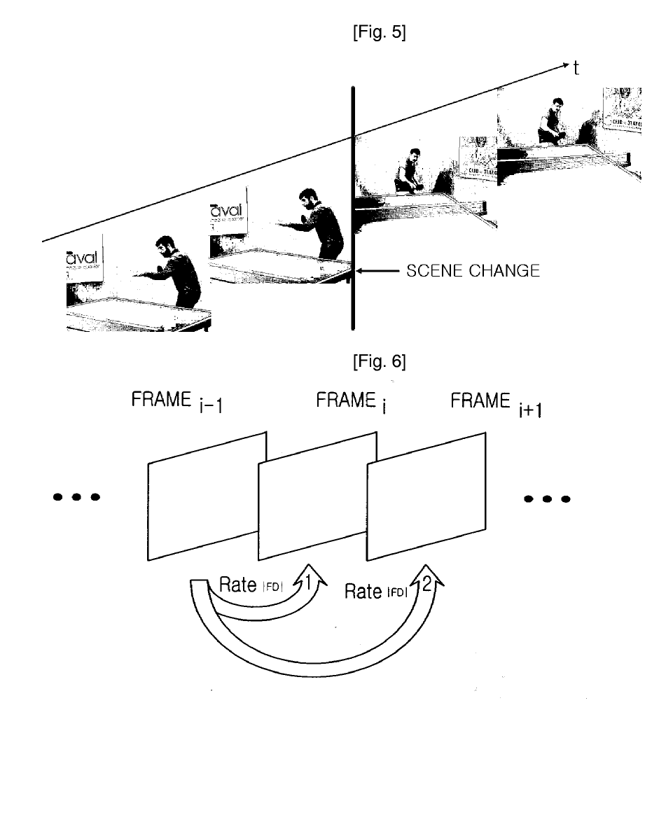

FIG. 5 shows a scene change of real frames. That is, FIG. 5 shows frames of a scene change portion in a video stream of a table tennis.

As shown in FIG. 5, there are not much movements of a person in frames of an identical scene. The scene change is a representative feature of digital video and generally used in a filed of a digital video search and identification technology.

However, it is not clear to identify a scene change in frames having a special effect such as overlap, fade-in, fade-out and cross-fade. Such frames are defined as a continuous scene change. The continuous scene change may be created according to an intention of a digital video producer. However, it may also generated unintentionally by a frame rate variation in a digital video.

To detect scene change, we can employ a lot of scene change detection schemes. An operation for searching such a continuous scene change increases a processing amount and complexity. Therefore, it is not proper to apply such a principle to the real-time digital video identification system. Accordingly, a trade-off is required between a searching accuracy and a real-time process for the continuous scene change. The present invention proposes a method allowing the real-time detection of a scene change while searching a continuous scene change with a proper level performance.

The detection of scene change in the present invention is based on a method using a reconstructed frame instead of using a predetermined video compression domain.

At first, operations of the difference extractor 11 shown in FIG. 2 will be described in detail.

The difference extractor 11 may use one of parameters such as a sum of absolute values of difference between frames, a rate of brightness variation between frames larger than a threshold, a sum of histogram differences between frames and a block-based inter-relation and so on.

The sum of absolute values of brightness differences between frames may be insensible when a great value variation is occurred at a small area or a small value variation is occurred at a large area although the sum of absolute values of brightness differences between frames has a large value at the scene change portion.

Generally, a brightness distribution is varied when a scene is changed. However, the variation of brightness distribution is small when an object moves in a frame. Therefore, the sum of differences between histograms of frames has small variation in a same scene. The block based inter-relation is similar to find a motion vector, which is used in a motion picture compression scheme, and it is applied under an assumption that the movement is very small in an identical scene. Therefore, the block based correlation reduces the object movement and the camera operation. However, a method of calculating the sum of histogram difference between frames and a method of obtaining the block based correlation between frames require a comparatively large amount of computation. Therefore, the present invention uses the rate of brightness variation between frames larger than a threshold regard to a view of a real-time processing and the detection performance.

If brightness values of locations x, y at a time t is I_{x,y}(t), the brightness difference ΔI_{x,y}(t) is defined as following Eq. 1.

ΔI_{x,y}(t)=|I_{x,y}(t+Δt)−I_{x,y}(t)| Eq. 1

If n( ) denotes the number of elements in a set and b is the number of bits to express a brightness of a frame, a rate of brightness variation between frames larger than a threshold is defined as following Eq. 2.

$${Rate}_{\vert FD \vert} ( t ) = \frac{n ( \{ Δ {I}_{x , y} ( t ) \vert {2}^{b - 4} < Δ {I}_{x , y} ( t ) \} )}{{x}_{max} \times {y}_{max}} \qquad Eq . 2$$

In Eq. 2, 2^{b-4} denotes an experimental threshold value. If b is 8, the brightness value is one from 0 to 255 and the threshold value is 16. Since the rate of brightness variation between frames larger than the threshold has a non-linear relation with the brightness difference, it will be used for searching the scene change.

The parameters for detecting the scene change according to the present invention, such as the rate of brightness variation between frames larger than the threshold, the sum of absolute values of brightness differences between frames, the sum of histogram difference between frames and the block based correlation, have a large value at a boundary area between two scenes although the parameters have a small value in a same scene. Therefore, the scene change portion can be detected by defining a scene change portion having a value larger than the threshold among the calculated larger values. However, such methods have a high error detecting rate in digital video having a frame rate changed in a middle of the scene, a slow image photographed by a high-speed shutter camera, an animation having the less number of frames, an image having strong lights such as lighting, explosion and camera flash and an image having a continuous scene change. Therefore, a scene change detection filtering is performed based on the rate of brightness variation between the frames without directly using the extracted parameters. That is, the scene information extractor 10 feeds the difference extractor 11 into the scene change detecting filter 12 so as to reduce the error detection rate. In the present invention, the rate of brightness variation between the frames is used as input of the scene change detecting filter 12 configured of a local maximum filter and a minimum filter, which allows a simple computation and a real-time processing. And then, the scene change detecting filter 12 obtains a frame location of scene change when a output passing through the scene change detecting filter 12 is larger than a threshold.

The filter generating a maximum value and a minimum value at a predetermined region can be defined as following Eq. 3, and Eq. 4.

$$\begin{matrix}{MX}_{th} ( t ) = max ( {Rate}_{\vert FD \vert} ( t + j ) ) if only , \\ - \frac{th}{2} \leq j \leq \frac{th}{2} - 1 & Eq . 3 \\ {MN}_{th} ( t ) = min ( {Rate}_{\vert FD \vert} ( t + k ) ) if only , \\ - \frac{th}{2} + 1 \leq k \leq \frac{th}{2} & Eq . 4\end{matrix}$$

Using Eqs. 3 and 4, the operation of the scene detection filter 12 can be expressed as following Eq. 5.

SCDF(t)=MN₄(MX₄(t))−MX₂(MN₂(MN₄(MX₄(t)))) Eq. 5

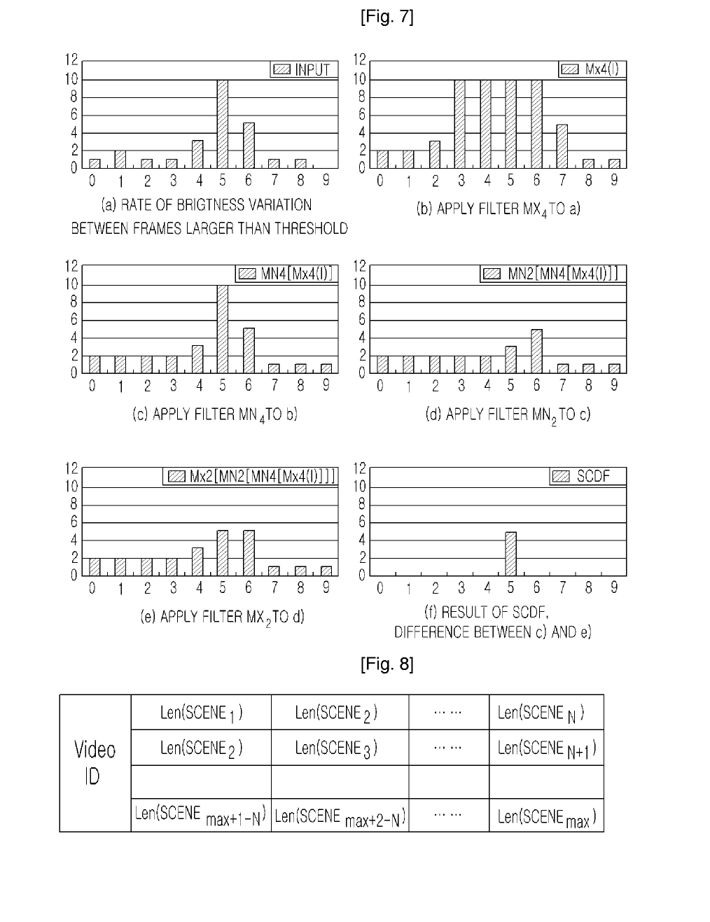

FIG. 7 shows graphs for describing operations of the scene detection filter 12 shown in FIG. 2.

A graph (a) in FIG. 7 shows the rate of brightness variation between the frames larger than the threshold as an example of the input of the scene detection filter 12. Then, MX₄, MN₄, MN₂ and MX₂ filters are sequentially applied to the input shown in the graph (a) of FIG. 7 according to Eq. 5 in order to calculate a scene change filtering result SCDF(t) as shown in graphs (b) to (e) in FIG. 7. Finally, a difference between the results (c) and (e) is obtained as the filtering result SCDF(t). The output of the SCDF(t) is mostly close to zero and has a comparative-large value at the scene change portion. Therefore, the output of the SCDF(t) can be used to detect the scene change portion with the threshold. Herein, the threshold value is an experimental value and if the input is greater than 0.2, a corresponding scene is detected as the scene change portion.

After detecting the scene change portion, the scene length calculator 13 computes the scene length using following Eq. 6 as shown in FIG. 4. If it assumes that a location (x) expresses a frame location of x, the length of the scene SCENEi is a difference between the scene change SCᵢ and SCᵢ₋₁. The difference is defined as the length of the scene change for the scene SCENEᵢ.

length(SCENEᵢ)=location(SCᵢ)−location(SCᵢ₋₁) Eq. 6

The computed scene length inputs to the digital video comparator 30 as shown in FIG. 1. The digital video comparator 30 queries the digital video database 20 using a universal database management system about to find a digital video stored in the database identical to a currently inputted digital video. It becomes difficult to process in real time if the digital video comparator 30 directly searches the digital video database 30 to find the identical digital video based on a measure reference. Therefore, it is essential to use the maximum performance of database through using a universal database system such as MySQL, Oracle and so on.

In order to build a database in the digital video database 30 to use the scene length, the scene length is stored with the corresponding digital video when the digital video is stored in the digital video database. If the scene length is stored as one object, it is difficult to search a target scene length from the database. Also, the digital video comparator 30 must perform a computation to each of stored objects based on the measure reference. Therefore, a work load of entire system increases. Since the digital video database 30 simply stores information and provides the stored information in response to external requests, the scene length is divided into N attributes and continuously arranged in an overlapping manner as shown in FIG. 8. A key value of database is defined as an ID of corresponding digital video. By building the digital video database as shown in FIG. 8, it helps to process necessary operations in real time in the present invention although it requires a more space to build the database.

In the present invention, the scene information extractor 10 calculates a scene length of a requested digital video in real time. Then, the digital video comparator 30 sends a query to the digital video database 20 based on the calculated scene length. The digital video database 20 outputs a video ID searched within a threshold per each scene length in response to the query. A beginning portion and an end portion of the frames may differ from that registered in the digital video database 20 due to some reason such as noise, compression error and so forth. Therefore, a grate threshold is set for the beginning and the end portions thereof. The digital video comparator 30 determines that the input digital video is in the digital video database 20 if the calculated scene length is identical to the scene length registered in the digital video database 20 within a threshold range based on the video ID from the digital video database 20. As described, it determines whether the input video is in the digital video database 20 or not.

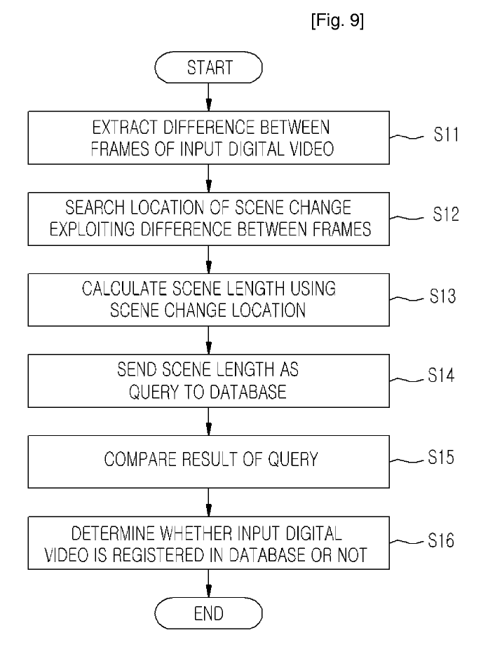

FIG. 9 is a flowchart showing a method of identifying a digital video in real time using a scene length according to an embodiment of the present invention.

Referring to FIG. 9, the scene information extractor 10 receives a digital video and the difference extractor 11 calculates a difference between frames at step S11. As described above, the difference between frames of the input digital video is extracted using a rate of brightness variation between frames larger than the threshold value as a parameter. Then, the scene change detecting filter 12 detects the location of scene changes at step S12. Moreover, a length of frames corresponding to a scene change portion is calculated as a scene length at the scene length calculator 13. That is, Eq. 6 is used to calculate the scene length in the step S13.

In order to provide a plurality of digital videos, a database of the plurality of digital videos is previously built. Such a digital video database also stores IDs of digital videos using a key value thereof and scene lengths thereof with being divided into N attributes. The scene information extractor 10 sends the calculated scene length to the digital video database 20 as a query at step S14. In response to the query, the digital database outputs the ID of digital video searched within a threshold per each scene length, and the calculated scene length is compared to a scene length registered with the ID at step S15.

If the calculated scene length is identical to the scene length of the digital video stored in the digital video database within the threshold range at the step S15, it determines that the input digital video is already registered at the digital video database at step S16. That is, it determines whether the input digital video is in the digital video database or not in real time according to the present invention.

It will be apparent to those skilled in the art that various modifications and variations can be made in the present invention. Thus, it is intended that the present invention covers the modifications and variations of this invention provided they come within the scope of the appended claims and their equivalents.

1. A real-time digital video identification system comprising:
a scene information extractor for receiving a digital video, extracting a difference between frames of the received digital video and calculating a scene length using the extracted difference;
a digital video database system for storing a plurality of digital videos and scene lengths corresponding to the stored digital videos; and
a digital video comparator for receiving the calculated scene length from the scene information extractor, sending a query to the digital video database and comparing the received scene length with the response of the query from the database system.

2. The real-time digital video identification system of claim 1, wherein the scene information extractor includes:
a difference extractor for receiving a digital video and detecting a scene change portion of the digital video based on a predetermined parameter; and
a scene change detecting filter for calculating a scene length using the parameter after performing a scene change detection filtering based on the parameter.

3. The real-time digital video identification system of claim 2, wherein the parameter is a rate of brightness variation between frames larger than a threshold.

4. The real-time digital video identification system of claim 1, wherein the digital video database stores N scene lengths as one object when a plurality of digital video and scene lengths thereof are stored in the digital video database.

5. A method of identifying a digital video in real time comprising the steps of:
a) extracting a difference between frames of an input digital video using a rate of brightness variation larger than a threshold between frames of the input digital video;
b) detecting the location of scene change exploiting the scene change detecting filter
c) calculating a length of frames as a scene length using the extracted scene change portion of the digital video at the step b);
d) sending the calculated scene length as a query to a digital video database previously built;
e) comparing the calculated scene length with a scene length registered corresponding to a digital video ID outputted as a result of the query; and
f) determining whether a currently inputted digital video is registered in the digital video database or not through determining whether the calculated scene length is identical to a scene length of a digital video registered in the database within a threshold range.

6. The method of claim 5, wherein the digital video database defines IDs(or NAMEs) of digital videos as a key value and stores N scene lengths for each ID as an attribute.
